(19) United States
(12) Patent Application Publication
(10) Pub. No.: US 2015/0125706 A1
(43) Pub. Date: May 7, 2015

(54) Projection screen

(71) Applicants: Ming-Hsin Liu, Changhua (TW); Chih-Sen Huang, Changhua (TW)

(72) Inventors: Ming-Hsin Liu, Changhua (TW); Chih-Sen Huang, Changhua (TW)

(21) Appl. No.: 14/072,806

(22) Filed: Nov. 6, 2013

(51) Int. Cl. G03B 21/60

(52) U.S. Cl. CPC G03B 21/60
USPC 428/442

(57) ABSTRACT

A projection screen is provided with a glass layer; a fiber layer disposed on the glass layer; a PVC layer disposed on the fiber layer; and a coating including PMMA, n-Butyl acetate, p-Xylene, mica, quartz, and nanometer silver and disposed on the PVC layer. The projection screen renders a high-definition image.

### BACKGROUND OF THE INVENTION

1. Field of the Invention

The invention relates to projection screens and more particularly to a projection screen capable of displaying a high-definition image.

2. Description of Related Art

A conventional projection screen comprises a base sheet having a first side and a second side opposite to the first side wherein first and second surfaces are formed on the first side, each first surface faces an optical projection system, each second surface is disposed between two adjacent first surfaces and forms an angle with respect to a neighboring first surface; a surface roughness structure formed on at least one of the first surfaces and capable of diffusing light emitted by the projection system to a limited extent; a reflective layer formed on the surface roughness structure and capable of reflecting most light diffused by the surface roughness structure to a limited extent towards a limited viewing cone, wherein a half-intensity angle of the light diffused by the surface roughness structure is less than or equal to 30 degrees; and a light absorption layer formed on the second surfaces.

However, image shown on the conventional projection screen is not high in definition. Thus, the need for improvement still exists.

### SUMMARY OF THE INVENTION

It is therefore one object of the invention to provide a projection screen comprising a glass layer; a fiber layer disposed on the glass layer; a PVC (polyvinyl chloride) layer disposed on the fiber layer; and a coating including PMMA (polymethyl methacrylate), n-Butyl acetate, p-Xylene, mica, quartz, and nanometer silver and disposed on the PVC layer.

The above and other objects, features and advantages of the invention will become apparent from the following detailed description taken with the accompanying drawings.

### BRIEF DESCRIPTION OF THE DRAWINGS

FIG. 1 is an exploded view of a projection screen according to the invention;

FIG. 2 is a perspective view of the projection screen;

FIG. 3 is a longitudinal sectional view of the projection screen of FIG. 2;

FIG. 4 is a perspective view of the projection screen being fully pulled down from a projection screen assembly;

FIG. 5 is a view similar to FIG. 4 showing the projection screen being pulled up; and

FIG. 6 is a perspective view of a slide projector projecting a high-definition image on the projection screen.

### DETAILED DESCRIPTION OF THE INVENTION

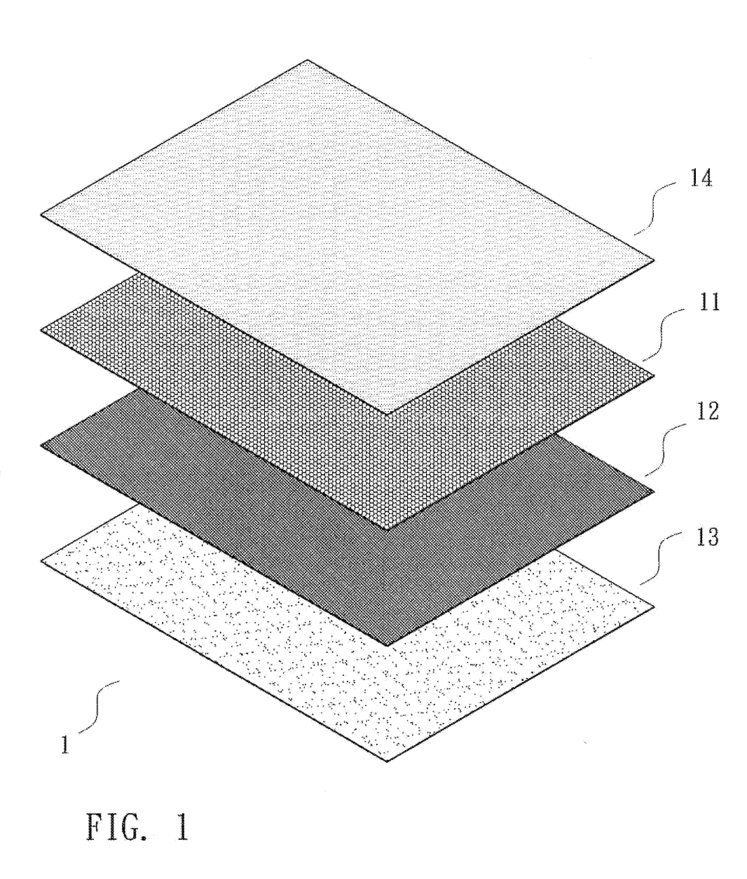

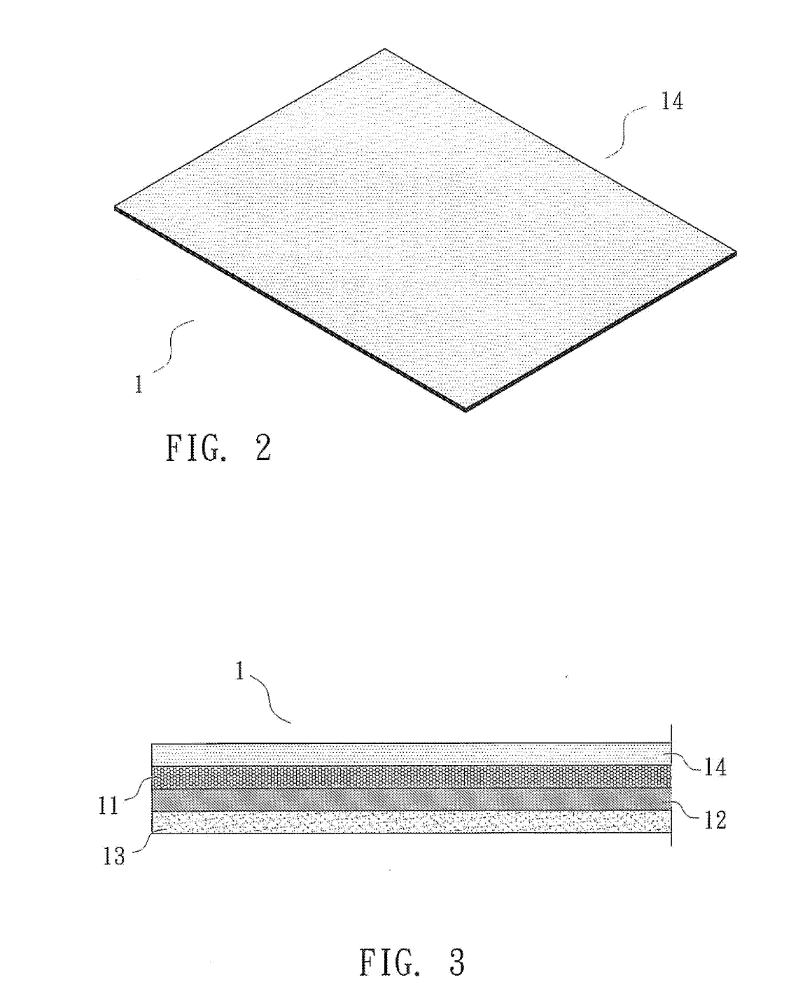

Referring to FIGS. 1 to 6, a projection screen 1 in accordance with the invention comprises the following components as discussed in detail below. A glass layer 13 is provided. A fiber layer 12 is provided on the glass layer 13. A PVC (polyvinyl chloride) layer 11 is provided on the fiber layer 12. An artificial fabric consists of the glass layer 13, the fiber layer 12, and the PVC layer 11. Finally, a coating 14 is a mixture of PMMA (polymethyl methacrylate), n-Butyl acetate, p-Xylene, mica, quartz, and nanometer silver and is provided on the PVC layer 11.

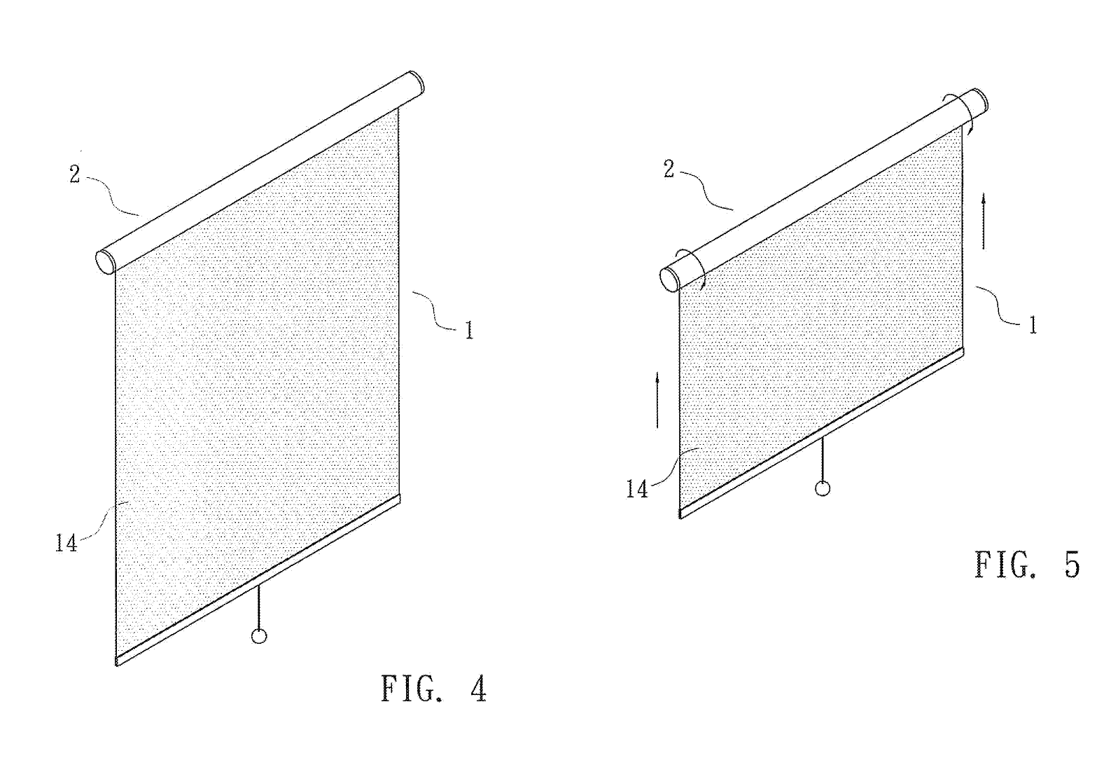

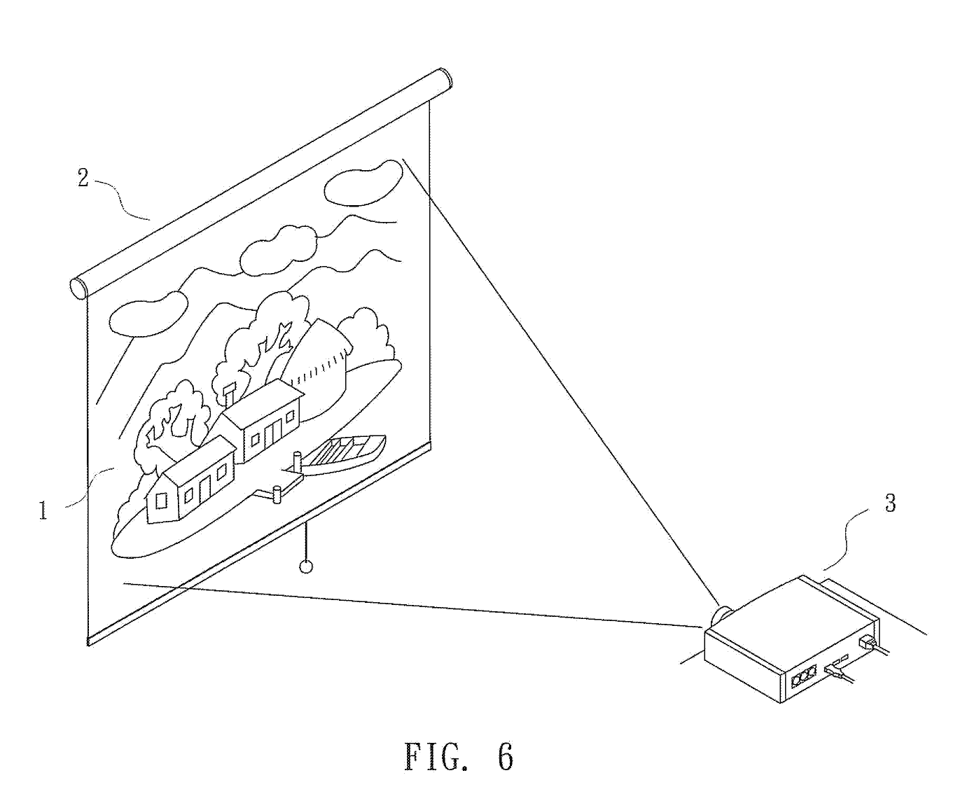

The projection screen 1 is wrapped in a rolling device 2. The projection screen 1 can be fully pulled down from the rolling device 2 to be ready to use (see FIG. 4). The projection screen 1 can be pulled up by clockwise rotating the rolling device 2 after use (see FIG. 5). A slide projector 3 is activated to project a high-definition image on the projection screen 1 (see FIG. 6).

While the invention has been described in terms of preferred embodiments, those skilled in the art will recognize that the invention can be practiced with modifications within the spirit and scope of the appended claims.

What is claimed is:

1. A projection screen comprising:
a glass layer;
a fiber layer disposed on the glass layer;
a PVC (polyvinyl chloride) layer disposed on the fiber layer; and
a coating including PMMA (polymethyl methacrylate), n-Butyl acetate, p-Xylene, mica, quartz, and nanometer silver and disposed on the PVC layer.
